(19) United States
(12) Patent Application Publication
(10) Pub. No.: US 2005/0188185 A1
(43) Pub. Date: Aug. 25, 2005

(54) Method and apparatus for predicate implementation using selective conversion to micro-operations

(76) Inventor: Edward T. Grochowski, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/783,765

(22) Filed: Feb. 20, 2004

(51) Int. Cl. G06F 9/00

(52) U.S. Cl. 712/226; 712/245

(57) ABSTRACT

A method and apparatus for implementing predicated instructions using selective conversion to micro-operations is presented. In one embodiment, the predicated instructions may have both a prediction of the predicate value and an indication of the confidence value of that predicted predicate value generated. When the confidence value of the prediction is low, then the predicated instruction may be decomposed into a set of micro-operations that should execute whether the predicate value is true or false. But when the confidence value is high, then the predicated instruction may be decomposed into simpler sets of micro-operations, for the cases when the predicted predicate value is true and for when it is false.

### FIELD

The present disclosure relates generally to microprocessors that employ predication, and more specifically to microprocessors capable of out-of-order (OOO) execution.

### BACKGROUND

Modern microprocessors may support the use of predication in their architectures. A predicated instruction is one that has a qualifying predicate associated with it. When the value of the qualifying predicate is determined to be true, then the instruction is permitted to execute and update the processor's state. When, however, the value of the qualifying predicate is determined to be false, then the instruction is not permitted to update the processor's state. For example, the instruction:
(p2) mov r10=r11
will copy the value of r11 into r10 if predicate p2 is true. If predicate p2 is false, r10 retains its original value.

Predicated instructions may be inserted into program code by the compiler to replace conditional branch instructions. In many implementations this may enhance processor efficiency. But in a processor that supports out-of-order (OOO) execution of instructions, the predicated instructions may cause problems. The predicated instructions generally have more source operands than the corresponding non-predicated instructions. To support OOO execution, processors generally require an additional register renaming stage, and adding even the capacity to support one more source operand may greatly magnify the complexity of such a stage. For this reason the direct support of predicated instructions in processor capable of 000 execution may not be practical. It would be possible to compile the code separately into predicated versions and non-predicated versions, but again this may not be practical.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of a processor and its execution pipeline showing a predicate predictor, according to one embodiment.

FIG. 2A is a diagram showing a predicated instruction, according to one embodiment.

FIG. 2B is a diagram showing a predicated instruction decomposed into micro-ops where the predicate value cannot be confidently predicted, according to one embodiment.

FIG. 2C is a diagram showing a predicated instruction decomposed into micro-ops where the predicate value is confidently predicted true, according to one embodiment.

FIG. 2D is a diagram showing a predicated instruction decomposed into micro-ops where the predicate value is confidently predicted true, according to one embodiment.

FIG. 3 is a diagram showing a predicate predictor with confidence value output, according to one embodiment of the present disclosure.

FIG. 4 is a flowchart of the decomposition of a predicated instruction for out-of-order execution, according to one embodiment of the present disclosure.

FIGS. 5A and 5B are schematic diagrams of systems including a processor supporting a predicate predictor and micro-op generator, according to two embodiments of the present disclosure.

### DETAILED DESCRIPTION

The following description describes techniques for executing predicated instructions in a processor capable of out-of-order (OOO) execution. In the following description, numerous specific details such as logic implementations, software module allocation, bus signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. In certain embodiments the invention is disclosed in the form of an Itanium® Processor Family (IPF) compatible processor such as those produced by Intel® Corporation. However, the invention may be practiced in other kinds of processors, such as an X-Scale® family compatible processor, that may wish to execute predicated instructions in an OOO environment.

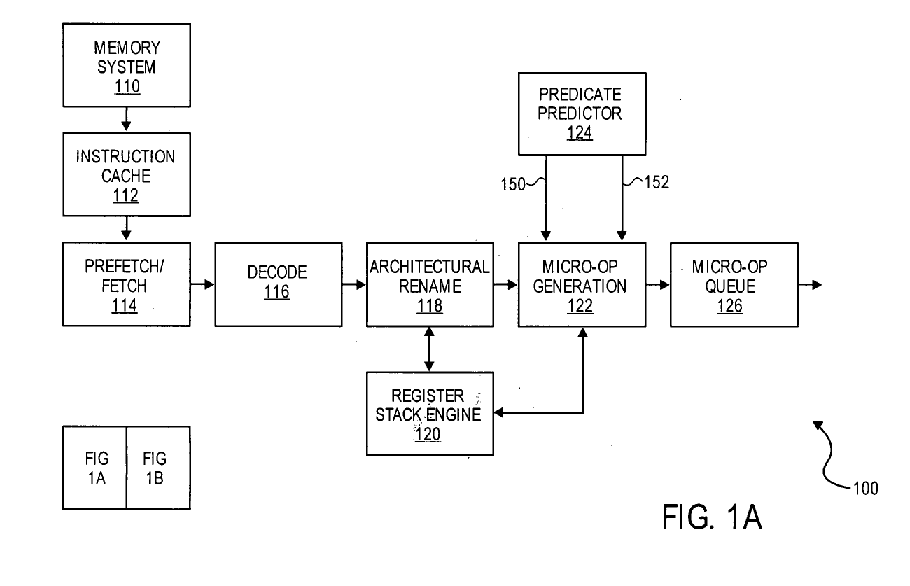

Referring now to FIG. 1, a schematic diagram of a processor and its execution pipeline showing a predicate predictor is shown, according to one embodiment. Instructions are fetched or prefetched from various levels of instruction cache 12 and memory system 10 by a prefetch/fetch stage 114. The instructions are then decoded by a decode stage 116. Once decoded, the instructions may have their architecturally-visible registers (i.e. those registers named in software code) renamed to RSE registers by an architectural rename stage 118. In one embodiment, the architectural rename stage 118 is supported by a register stack engine 120 that permits the spilling to the register stack backing store of only those registers actually allocated to a function. In other embodiments, the architecturally-visible registers may be renamed to physical registers without the intermediate RSE register stage.

Once the instructions have their architecturally-visible registers renamed to RSE registers, each instruction may then be represented by a set of one or more micro-operations (micro-ops). The corresponding sets of micro-ops may be issued by a micro-op generation stage 122. The micro-ops may use the RSE register renaming provided by the architectural rename stage 118 and register stack engine 120.

In one embodiment, the set of micro-ops corresponding to an instruction with a predicate may vary depending upon predictions made about the predicate's value by a predicate predictor 124. The predicate predictor 124 may send both a predicted predicate value signal 150 and a confidence value signal 152 to the micro-op generation stage 122. In one embodiment, the predicted predicate value signal 150 may indicate whether the predicted predicate value is either true or false. The confidence value signal 152 may indicate whether the confidence determined for the corresponding predicted predicate value is high or low by indicating true and false. In other embodiments, the confidence value signal 152 may indicate whether the confidence determined for the corresponding predicted predicate value is high or low by indicating a numerical value which the micro-op generation stage 122 may use to determine whether the confidence value is high or low.

When the confidence value signal 152 indicates a high confidence for the predicted predicate value of an instruction, micro-op generation stage 122 may issue one set of micro-ops corresponding to that instruction if the predicted predicate value is “true”, and a different set of micro-ops corresponding to that instruction if the predicted predicate value is “false”. These sets of micro-ops may have simpler data dependencies than a set of micro-ops which may be issued without any prediction of the predicate value. Such a set of micro-ops may be issued when the confidence value signal 152 indicates a low confidence for the predicted predicate value of that instruction.

Sets of micro-ops issuing from micro-op generation stage 122 may be held in a micro-op queue 126 prior to having their RSE registers renamed to physical registers in order to support subsequent OOO execution. In one embodiment, an OOO physical rename stage 128 may make use of a rename map table 130 to map RSE registers to physical registers 132. Once the renaming to physical registers is performed, then the micro-ops may be scheduled and dispatched by a schedule stage 136 and a dispatch stage 138, respectively.

The micro-ops may then be executed in an execution stage 140. In one embodiment, execution stage 140 may include several execution units. In one embodiment, these several execution units may be of several specialized types, such as branch execution units, floating point execution units, and integer execution units. It is noteworthy that the actual determination of a predicate value may first be made in the execution stage 140, when the predicate value is calculated. The execution results from the execution stage 140 may then be put back into program order in a re-order buffer 142 prior to updating the machine state in a retirement stage 144.

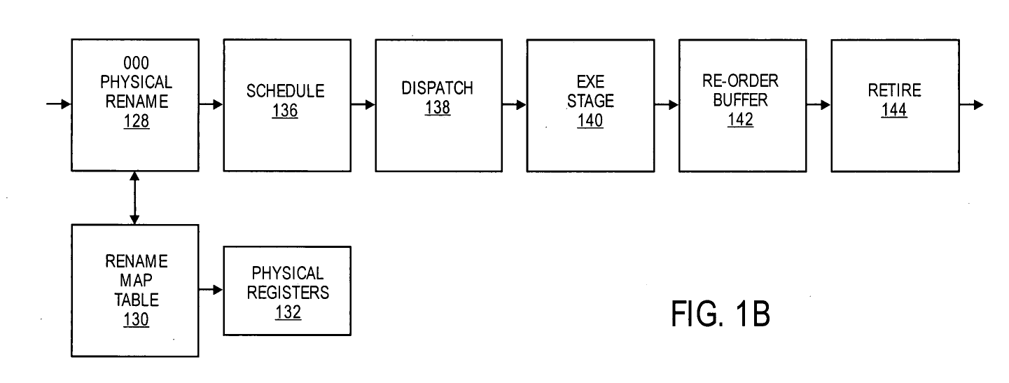

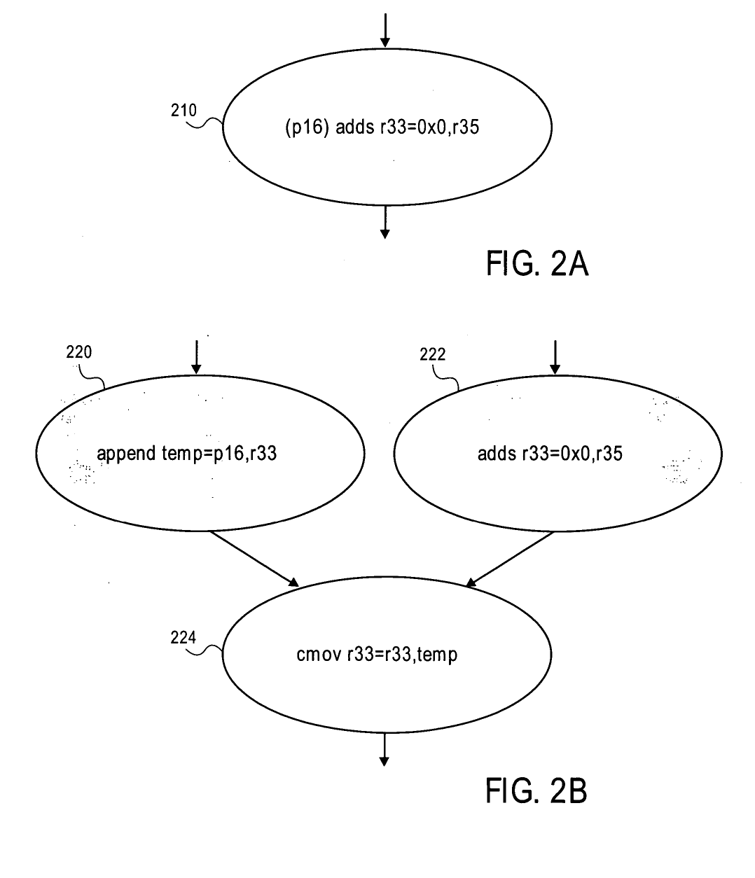

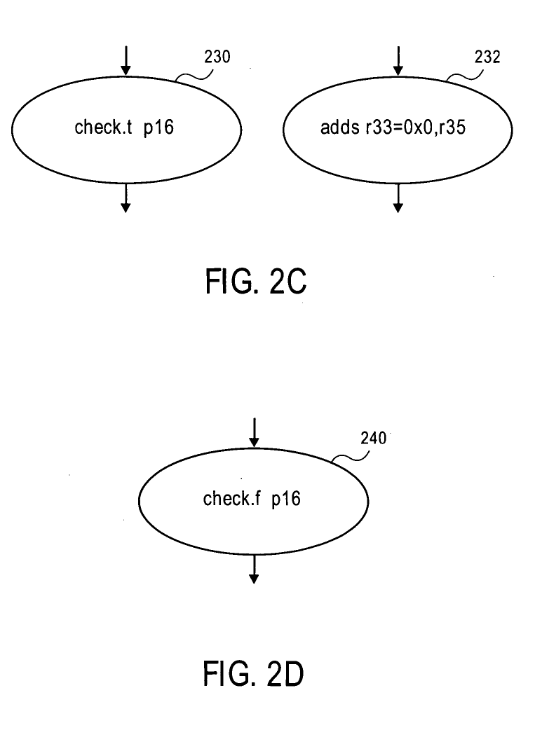

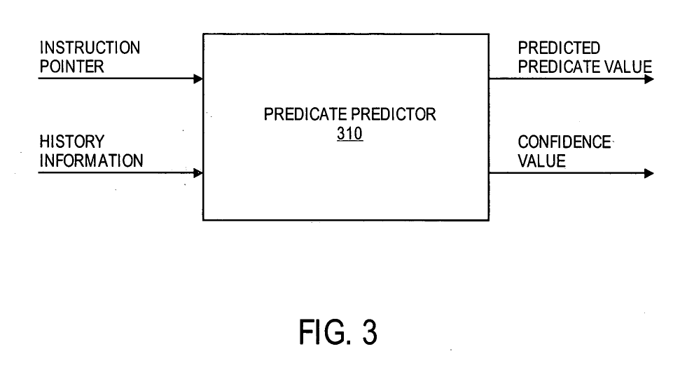

Referring now to FIG. 2A, a diagram of a predicated instruction 210 is shown, according to one embodiment. This instruction 210 is shown as generated by a compiler. In this embodiment, the instruction 210 has a qualifying predicate (qp) in predicate register p16, a destination architecturally-visible register r33, and a source architecturally-visible register r35. In effect, instruction 210 actually has three source registers: p16, r35, and the initial value of r33. If p16 is later determined to be false, then the initial value of r33 must be restored. If the constant value 0×0 had instead been another source architecturally-visible register, say r23, then the instruction would have actually had four source registers: p16, r23, r35, and the initial value of r33.

Referring now to FIG. 2B, a diagram of a predicated instruction decomposed into micro-ops where the predicate value cannot be confidently predicted is shown, according to one embodiment. The instruction 210 may be decomposed into micro-ops 220, 222, and 224 which collectively perform the operations of instruction 210. In effect, the initial value of r33 is placed into a temp register in micro-op 220. When the value of the predicate register is finally calculated, the conditional move (cmov) of micro-op 224 may then place either the results of micro-op 222 in r33 or the initial value of r33 in temp into r33. When instruction 210 is decomposed into micro-ops 220, 222, and 224, the three source registers pl6, r35, and the initial value of r33 are reduced to only at most two source registers per micro-op. In the case of micro-op 220, the two source registers are p16 and r33. In the case of micro-op 222, the one source register is r35. In the case of micro-op 224, the two source registers are r33 and temp.

Using a decomposition method such as shown in FIG. 2B, other predicated instructions may be represented by a set of one or more micro-ops. Generally these may reduce the predicated instruction, with up to four source registers, into a set of micro-ops each requiring only up to two source registers. In Table 1, several examples of predicated instructions are shown with one embodiment of a decomposition of the predicated instruction into a set of one or more corresponding micro-ops. Each predicated instruction is one of those in the Itanium® Processor Family (IPF) instruction set.

TABLE 1

| Instructions | | Micro-op Sequences | |
|---|---|---|---|
| 1. | (qp) add r1 = r2, r3 | 1a | append temp = r1, qp |
| | | 1b | add r1 = r2, r3 |
| | | 1c | cmov r1 = temp, r1 |
| 2. | (qp) 1d4 r1 = [r3], r2 | 2a | append temp1 = r1, qp |
| | | 2b | append temp2 = r3, qp |
| | | 2c | 1d4 r1 = [r3] |
| | | 2d | add r3 = r3, r2 |
| | | 2e | cmov r1 = temp, r1 |
| | | 2f | cmov r3 = temp2, r3 |
| 3. | (qp) cmp.eq p1, p2 = r2, r3 | 3a | append p-temp1 = p1, qp |
| | | 3b | append p-temp2 = p2, qp |
| | | 3c | cmp.eq p1 = r2, r3 |
| | | 3d | cmp.ne p2 = r2, r3 |
| | | 3e | cmov p1 = p-temp1, p1 |
| | | 3f | cmov p2 = p-temp2, p2 |
| 4. | (qp) cmp.eq.unc p1, p2 = r2, | 4a | cmp.eq p1 = r2, r3 |
| | r3 | 4b | cmp.ne p2 = r2, r3 |
| | | 4c | cmov.unc p1 = qp, p1 |
| | | 4d | cmov.unc. p2 = qp, p2 |
| 5. | (qp) cmp.eq.or p1, p2 = r2, | 5a | append p-temp1 = p1, qp |
| | r3 | 5b | append p-temp2 = p2, qp |
| | | 5c | cmp.eq p1 = 2, r3 |
| | | 5d | cmp.eq p2 = r2, r3 |
| | | 5e | cmov.or p1 = p-temp1, |
| | | | p1 |
| | | 5f | cmov.or p2 = p-temp2, |
| | | | p2 |

Similar decompositions may be used for other instructions in the IPF instruction set, and in other embodiments similar decompositions may be used for instructions in other instruction sets that may use predication. For more details about decompositions in the IPF, see U.S. patent application Ser. No. 0/685,654, entitled “Method and Apparatus for Predication Using Micro-ops”, which is commonly assigned with the present application.

Referring now to FIG. 2C, a diagram of a predicated instruction decomposed into micro-ops where the predicate value is confidently predicted true is shown, according to one embodiment. When the predicate value is confidently predicted to be true, then only two micro-ops 230, 232 may be required as opposed to the three micro-ops shown in FIG. 2B. Micro-op 230 may use a check.t for the qualifying predicate p16. The check.t micro-op may test the eventual calculated value of the qualifying predicate pl6 to see if it is true. If the calculated value is in fact true, then the check.t micro-op has no further effect on the machine state. If, however, the calculated value is false, then the check.t micro-op may initiate a recovery procedure. Micro-op 232 may be the instruction 210 without predicate. Another way of saying this is that micro-op 232 may be equivalent to a micro-op performing the unconditional form of instruction 210, even in those cases where there is no unconditional form of instruction 210 is available in the instruction set. It may be noted that there is no data-dependency between micro-ops 230, 232 and this may be contrasted to the data dependencies of between micro-ops 220, 222 and 224 of FIG. 2B. However there may exist a control dependency between micro-op 230 and micro-op 232, because when the test of micro-op 230 fails, the result of micro-op 232 should not update the value of r33.

In one embodiment, the recovery procedure may be similar to that following a mispredicted branch instruction: the check.t performs its test in the execution stage and initiates a processor pipeline flush and recovery. In this embodiment there is the possibility of re-using some of the existing circuitry implemented for cases of mispredicted branches. In another embodiment, circuitry in the retirement stage may treat the recovery procedure as equivalent to an exception. The generally effect would be similar, in that the pipeline would be flushed. However it may be easier to accomplish this in the retirement stage because the instructions, placed in OOO form for execution, would be put back into original program order by the re-order buffer.

In other embodiments, the predicated instruction corresponding to instruction 210 may be one that may decode into a set of two or more micro-ops in non-predicated (unconditional) form. In these cases, the corresponding set of micro-ops when the qualifying predicate value is confidently predicted to be true would be that set of micro-ops and the check.t (qp) micro-op.

Referring now to FIG. 2D, a diagram of a predicated instruction decomposed into micro-ops where the predicate value is confidently predicted true is shown, according to one embodiment. When the predicate value is confidently predicted to be false, then only one micro-op 240 may be required as opposed to the three micro-ops shown in FIG. 2B. Micro-op 240 may use a check.f for the qualifying predicate pl6. The check.f micro-op may test the eventual calculated value of the qualifying predicate p16 to see if it is false. If the calculated value is in fact false, then the check.f micro-op has no further effect on the machine state. If, however, the calculated value is true, then the check.f micro-op may initiate a recovery procedure. The recovery procedures may be one of those discussed in connection with FIG. 2C above.

In other embodiments, the predicated instruction corresponding to instruction 210 may again be one that may decode into a set of two or more micro-ops in non-predicated (unconditional) form. In these cases, the corresponding set of micro-ops when the qualifying predicate value is confidently predicted to be false may be merely the check.f (qp) micro-op.

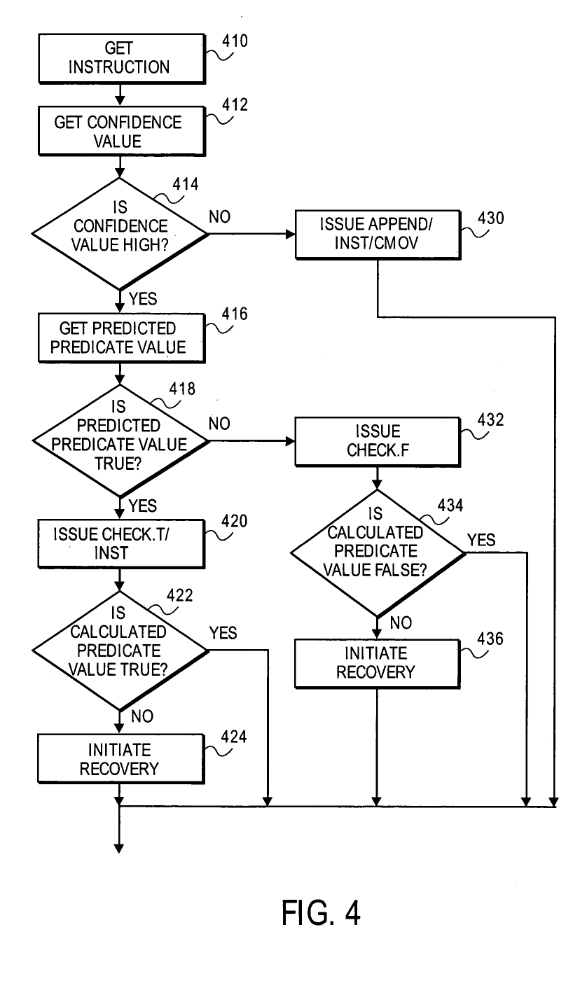

Referring now to FIG. 3, a diagram of a predicate predictor with confidence value output is shown, according to one embodiment of the present disclosure. In one embodiment, the predictor receives an instruction pointer corresponding to the predicated instruction, and has received history information during previous program execution. The predicted predicate value may be a signal indicating true or false to reflect the prediction. The confidence value may be a signal indicating true or false to reflect whether or not the predicate predictor has high or low confidence in the currently-presented predicted predicate value. In other embodiments, the confidence value may signal a number that may be interpreted by external circuitry as being of high or low confidence value. In some embodiments, the predicted predicate value show as a signal may present a “don't care” or indeterminate value when the confidence value is low.

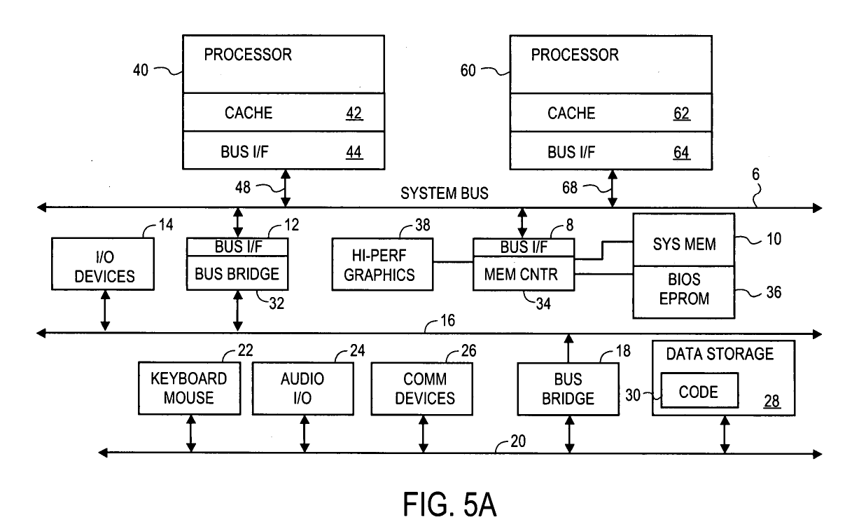

Referring now to FIG. 4, a flowchart of the decomposition of a predicated instruction for out-of-order execution is shown, according to one embodiment of the present disclosure. In block 410 the predicated instruction is presented. In block 412 the confidence value for the predicted predicate value of that instruction may be retrieved. Then in decision block 414 it may be determined whether the confidence value is high. If not, then the predicted predicate value may be ignored, and the decision block 414 exits via the NO path. In block 430 the set of micro-ops in the form of an append micro-op, one or more non-predicated instruction micro-ops, and a conditional move micro-op may be issued.

If, however the decision block 414 determines that the confidence value is high, then the decision block 414 exits via the YES path. The predicted predicate value may be retrieved in block 416, and then in decision block 418 it may be determined whether the predicted predicate value is true. If not, then the decision block 418 exits via the NO path and the check.f micro-op may be issued by itself. In decision block 434, it may be determined whether the calculated value of the predicate value is also false. If so, then the decision block 434 exits via the YES path and the process completes. If not, then the decision block 434 exits via the NO path and in block 436 a recovery process may be initiated.

If, however, in decision block 418 it is determined that the predicted predicate value is true, then the decision block 418 exits via the YES path and in block 420 a check.t micro-op, along with one or more non-predicated instruction micro-ops, may be issued. Then, in decision block 422, it may be determined whether the calculated value of the predicate value is also true. If so, then the decision block 4224 exits via the YES path and the process completes. If not, then the decision block 422 exits via the NO path and in block 424 a recovery process may be initiated.

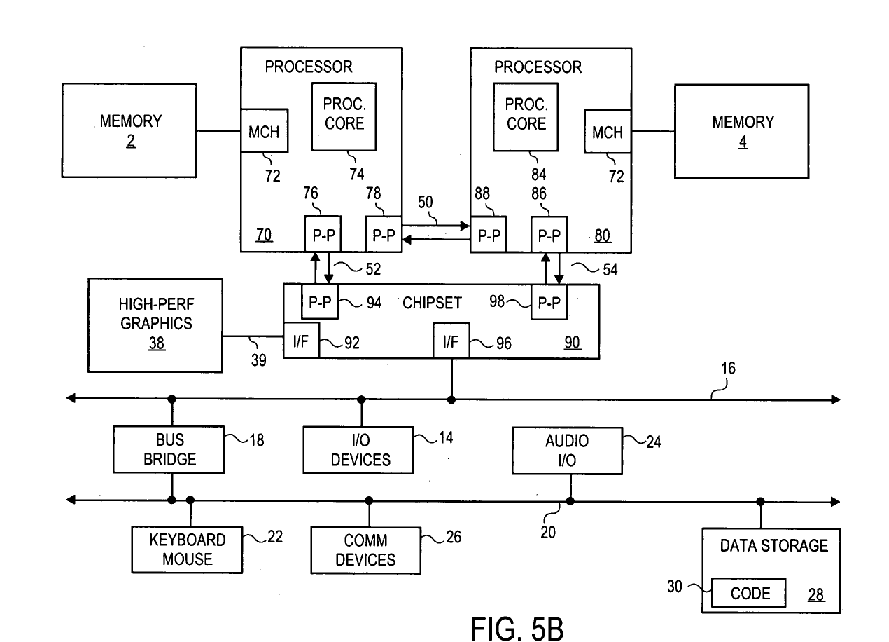

Referring now to FIGS. 5A and 5B, schematic diagrams of systems including a processor supporting a predicate predictor and micro-op generator are shown, according to two embodiments of the present disclosure. The FIG. 5A system generally shows a system where processors, memory, and input/output devices are interconnected by a system bus, whereas the FIG. 5B system generally shows a system where processors, memory, and input/output devices are interconnected by a number of point-to-point interfaces.

The FIG. 5A system may include several processors, of which only two, processors 40, 60 are shown for clarity. Processors 40, 60 may include level one caches 42, 62. The FIG. 5A system may have several functions connected via bus interfaces 44, 64, 12, 8 with a system bus 6. In one embodiment, system bus 6 may be the front side bus (FSB) utilized with Pentium® class microprocessors manufactured by Intel® Corporation. In other embodiments, other busses may be used. In some embodiments memory controller 34 and bus bridge 32 may collectively be referred to as a chipset. In some embodiments, functions of a chipset may be divided among physical chips differently than as shown in the FIG. 5A embodiment.

Memory controller 34 may permit processors 40, 60 to read and write from system memory 10 and from a basic input/output system (BIOS) erasable programmable read-only memory (EPROM) 36. In some embodiments BIOS EPROM 36 may utilize flash memory. Memory controller 34 may include a bus interface 8 to permit memory read and write data to be carried to and from bus agents on system bus 6. Memory controller 34 may also connect with a high-performance graphics circuit 38 across a high-performance graphics interface 39. In certain embodiments the high-performance graphics interface 39 may be an advanced graphics port AGP interface. Memory controller 34 may direct read data from system memory 10 to the high-performance graphics circuit 38 across high-performance graphics interface 39.

The FIG. 5B system may also include several processors, of which only two, processors 70, 80 are shown for clarity. Processors 70, 80 may each include a local memory controller hub (MCH) 72, 82 to connect with memory 2, 4. Processors 70, 80 may exchange data via a point-to-point interface 50 using point-to-point interface circuits 78, 88. Processors 70, 80 may each exchange data with a chipset 90 via individual point-to-point interfaces 52, 54 using point to point interface circuits 76, 94, 86, 98. Chipset 90 may also exchange data with a high-performance graphics circuit 38 via a high-performance graphics interface 92.

In the FIG. 5A system, bus bridge 32 may permit data exchanges between system bus 6 and bus 16, which may in some embodiments be a industry standard architecture (ISA) bus or a peripheral component interconnect (PCI) bus. In the FIG. 5B system, chipset 90 may exchange data with a bus 16 via a bus interface 96. In either system, there may be various input/output I/O devices 4 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A processor, comprising:
a predicate predictor to determine a predicted predicate value and a confidence value for a first instruction with a predicate; and
a micro-op generator to issue a first set of micro-ops corresponding to said first instruction when said confidence value is high and a second set of micro-ops corresponding to said first instruction when said confidence value is low.

2. The processor of claim 1, wherein said first set of micro-ops includes a check micro-op.

3. The processor of claim 2, wherein said check micro-op is to check for a calculated value of said predicate of true when said predicted predicate value is true.

4. The processor of claim 3, wherein said check micro-op is to initiate a recovery when said calculated value is false.

5. The processor of claim 3, wherein said first set of micro-ops includes a first micro-op corresponding to said first instruction without predicate.

6. The processor of claim 2, wherein said check micro-op is to check for a calculated value of said predicate of false when said predicted predicate value is false.

7. The processor of claim 6, wherein said check micro-op is to initiate a recovery when said calculated value is true.

8. The processor of claim 1, wherein said second set of micro-ops includes a micro-op corresponding to said first instruction without predicate.

9. The processor of claim 8, wherein said second set of micro-ops includes a conditional move micro-op.

10. A method, comprising:
determining a predicted predicate value for a first instruction with a predicate;
determining a confidence value for said predicted predicate value; and
issuing a set of micro-ops corresponding to said first instruction responsive to said confidence value.

11. The method of claim 10, wherein said set of micro-ops includes a check micro-op when said confidence value is high.

12. The method of claim 11, wherein said check micro-op checks for a calculated value of said predicate of true when said predicted predicate value is true.

13. The method of claim 12, further comprising initiating a recovery when said calculated value of said predicate is false.

14. The method of claim 12, further comprising issuing a first micro-op corresponding to said instruction without predicate.

15. The method of claim 11, wherein said check micro-op checks for a calculated value of said predicate of true when said predicted predicate value is false.

16. The method of claim 15, further comprising initiating a recovery when said calculated value of said predicate is true.

17. The method of claim 10, wherein said set of micro-ops includes a conditional move micro-op when said confidence value is low.

18. A system, comprising:
a processor including a predicate predictor to determine a predicted predicate value and a confidence value for a first instruction with a predicate, and a micro-op generator to issue a first set of micro-ops corresponding to said first instruction when said confidence value is high and a second set of micro-ops corresponding to said first instruction when said confidence value is low;
an interface to couple said processor to input-output devices; and
an audio input-output coupled to said interface and said processor.

19. The system of claim 18, wherein said first set of micro-ops includes a check micro-op.

20. The system of claim 19, wherein said check micro-op is to check for a calculated value of said predicate of true when said predicted predicate value is true.

21. The system of claim 20, wherein said check micro-op is to initiate a recovery when said calculated value is false.

22. The system of claim 21, wherein said first set of micro-ops includes a first micro-op corresponding to said first instruction without predicate.

23. The system of claim 19, wherein said check micro-op is to check for a calculated value of said predicate of false when said predicted predicate value is false.

24. The system of claim 23, wherein said check micro-op is to initiate a recovery when said calculated value is true.

25. The system of claim 18, wherein said second set of micro-ops includes a micro-op corresponding to said first instruction without predicate.

26. The system of claim 25, wherein said second set of micro-ops includes a conditional move micro-op.

27. An apparatus, comprising:
means for determining a predicted predicate value for a first instruction with a predicate;
means for determining a confidence value for said predicted predicate value; and
means for issuing a set of micro-ops corresponding to said first instruction responsive to said confidence value.

28. The apparatus of claim 27, wherein said set of micro-ops includes a check micro-op when said confidence value is high.

29. The apparatus of claim 28, wherein said check micro-op checks for a calculated value of said predicate of true when said predicted predicate value is true.

30. The apparatus of claim 29, further comprising means for initiating a recovery when said calculated value of said predicate is false.

31. The apparatus of claim 30, further comprising means for issuing a first micro-op corresponding to said instruction without predicate.

32. The apparatus of claim 28, wherein said check micro-op checks for a calculated value of said predicate of true when said predicted predicate value is false.

33. The apparatus of claim 32, further comprising means for initiating a recovery when said calculated value of said predicate is true.

34. The apparatus of claim 27, wherein said set of micro-ops includes a conditional move micro-op when said confidence value is low.
